(19) United States
(12) Patent Application Publication
(10) Pub. No.: US 2011/0271625 A1
(43) Pub. Date: Nov. 10, 2011

(54) THIN-LAYER COMPOSITES INCLUDING CELLULOSIC ANDNONCELLULOSIC FIBERS AND METHODS OF MAKING THE SAME

(75) Inventors: Randy Clark, Klamath Falls, OR (US); Kenneth D. Kiest, Klamath Falls, OR (US)

(73) Assignee: JELD-WEN, INC., Portland, OR (US)

(21) Appl. No.: 12/942,820

(22) Filed: Nov. 9, 2010

Related U.S. Application Data
(60) Provisional application No. 61/355,934, filed on Jun. 17, 2010.
(60) Provisional application No. 61/259,988, filed on Nov. 10, 2009.

(51) Int. Cl. E06B 3/30; B32B 27/12; B32B 21/02; C08K 7/14; E06B 3/26; C08L 97/02; C08L 75/04; B32B 5/02; B27N 3/12

(52) U.S. Cl. 52/309.13; 428/221; 428/220; 264/257; 52/784.1; 524/14

(57) ABSTRACT

A composite mixture for making a thin-layer composite product, such as a door skin, which includes cellulosic fibers, at least 1% by weight noncellulosic fibers, such as glass fibers, and at least 1% by weight of an isocyanate resin, and methods for making them. The noncellulosic fibers may be individualized before they come in contact with the resin.

### RELATED APPLICATIONS

This application claims priority to U.S. Provisional Application No. 61/355,934, filed Jun. 17, 2010, and U.S. Provisional Application No. 61/259,988, filed Nov. 10, 2009, the entire contents of which are hereby incorporated herein by reference.

### TECHNICAL FIELD

The field of this application relates generally to the manufacture of thin-layer composites and, more particularly but not exclusively, to composite door skins made from an isocyanate-based resin and cellulosic and noncellulosic fibers.

### BACKGROUND

A significant challenge in the manufacture of wood-based composite products that are exposed to extreme exterior and interior environments is that upon exposure to variations in temperature and moisture, the wood can lose moisture and shrink, or gain moisture and swell. This tendency to shrink and/or swell can significantly limit the useful lifetime of many interior or exterior wood products, such as wooden doors, often necessitating replacement after only a few years. The problem is particularly prevalent in extremely wet climates and extremely hot or dry climates. One way of addressing moisture gain and loss in wood that is exposed to the elements includes covering the wood with paint and/or other coatings that act as a barrier to moisture. Such coatings, however, tend to wear off with time, leaving the wood susceptible to the environment.

Alternatively, doors and other structural units may be covered with a wood-containing water-resistant layer. For example, doors may be covered with a thin-layer wood composite known as a door skin. Door skins are molded as thin layers to be adhesively secured to an underlying door frame or core, to thereby provide a water-resistant outer surface. Door skins may be made by mixing, in some examples, wood fiber, wax, and a resin binder, and then pressing the mixture under conditions of elevated temperature and pressure to form a thin-layer wood composite that is then bonded to the underlying door frame or core.

Wood composite door skins are conventionally formed by pressing wood fragments in the presence of a binder at temperatures exceeding 275° F. (135° C.). The resin binder used in the door skin may be a formaldehyde-based resin, an isocyanate-based resin, a thermoplastic or a thermoset resin. Formaldehyde-based resins typically used to make wood composite products include phenol-formaldehyde, urea-formaldehyde, or melamine-formaldehyde resins. Phenol-formaldehyde resins require a high temperature to cure and are sensitive to the amount of water in the wood, because excess water can inhibit the high temperature cure. Urea and melamine-formaldehyde resins do not require as high of a temperature cure, but traditionally do not provide comparable water-resistance (at the same resin content) in the door skin product.

Accordingly, a need exists for composite products, such as door skins, that consistently exhibit sufficient resistance to environmentally-induced swelling and/or shrinking to be commercially useful.

### BRIEF DESCRIPTION OF THE DRAWINGS

FIG. 1 is a simplified flow diagram showing some exemplary manufacturing steps for making thin-layer composites, such as a door skins.

FIG. 2 is a simplified flow diagram showing details of some exemplary manufacturing steps for making the thin-layer composites, including (a) mixing the cellulosic fiber, noncellulosic fiber, and resin to form a composite mixture; (b) forming the composite mixture into a loose mat; (c) spraying the loose mat with release agent; (d) pressing the mat between two dies; and (e) releasing the resultant thin-layered composite product.

FIG. 3 is a simplified flow diagram showing details of some exemplary process steps, including chopping and individualizing noncellulosic fibers and applying resin.

FIG. 4 is a magnified photograph at 60× of a thin-layered composite containing non-individualized noncellulosic fibers.

FIG. 5 is a scanning electron microscope micrograph showing a noncellulosic fiber surrounded by cellulosic fibers in an exemplary thin-layer composite.

### DETAILED DESCRIPTION

In embodiments of the method disclosed herein, cellulosic and noncellulosic fibers are employed to make thin-layer composites, such as door skins. Some embodiments provide for the manufacture of thin-layer composites that include levels of isocyanate-based resins and noncellulosic fibers that protect the composite from shrinking and swelling upon exposure to environmental conditions. The methods and compositions disclosed herein may be applied to various types of cellulosic thin-layer composites to generate structural units that may withstand weathering by heat, moisture, sunlight, air, and the like.

As will be explained in greater detail below, the noncellulosic fibers may include synthetic fibers such as mineral fibers and polymer fibers. In certain embodiments, the noncellulosic fibers are glass fibers. The noncellulosic fibers may be individualized, or separated into individual filaments. Using noncellulosic and cellulosic fibers with an isocyanate resin allows the isocyanate resin to interact with the wood fibers and noncellulosic fibers such that the door skin has an improved resistance to moisture. In an exemplary embodiment, the advantages of using noncellulosic material included a lower percent linear expansion and a lower coefficient of hygroexpansion for door skins which included noncellulosic fibers, compared to door skins without them. Also, the strength of a door skin which included noncellulosic fibers, compared to door skins without them, was higher.

As used herein, a thin-layer composite comprises a generally flat, planar structure that is significantly longer and wider than it is thick. Examples of thin-layer cellulosic composites include wood-based door skins that are used to cover the frame or core of a door to provide the outer surface of the door. Such door skins may have composite sheets that are only about 1 to about 13 mm thick, but may have a surface area of about 24 square feet (about 2.23 square meters) or more. Door skins may be flat or smooth or may be contoured to simulate a paneled construction. Other thin-layer cellulosic products may include Medium Density Fiberboard (MDF), hardboard, particleboard, Oriented Strand Board (OSB) and other panel products made with wood. These products may have composite sheets that are normally about 2 to about 30 mm in thickness.

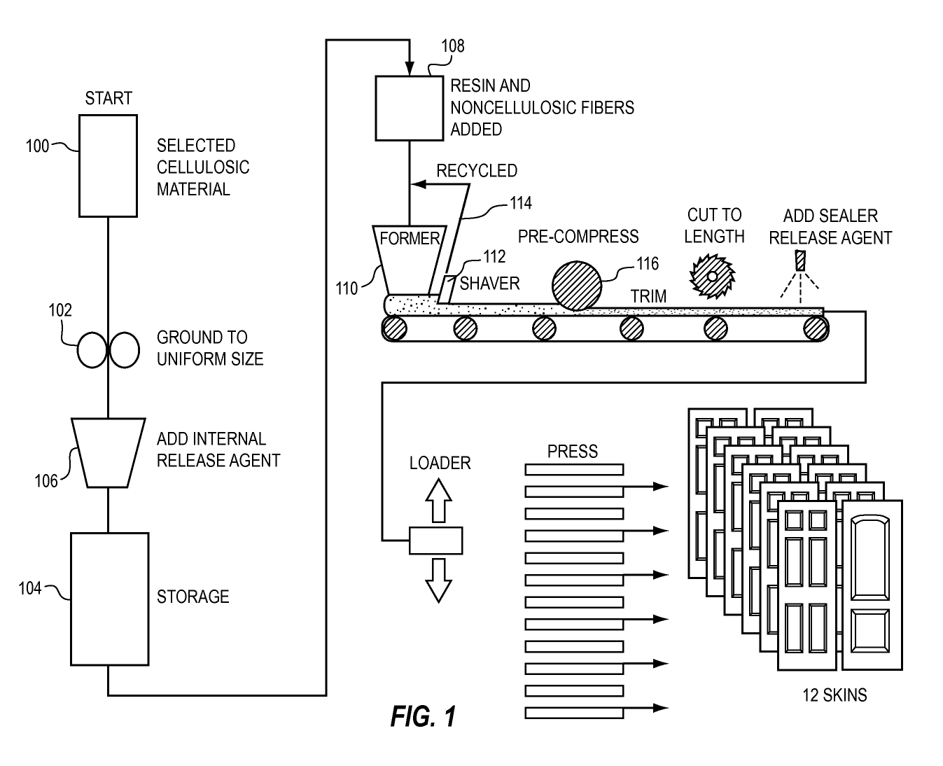

FIG. 1 shows an overview of exemplary manufacturing steps for making thin-layer cellulosic composites. Wood chips may serve as a selected cellulosic starting material. The wood chips may be ground, or refined, to prepare fibers of a substantially uniform size, and an appropriate amount of an optional release agent may be added. A wax and/or a catalyst may also be added. After refining, the cellulosic fibers may be dried to a specific moisture content or to within a specific moisture content range, such as between about 7% and about 20% by weight.

In some embodiments, the moisture content of the cellulosic fibers is between about 7% and about 20% by weight previous to forming the finished thin layer composite. In other embodiments, the moisture content of the cellulosic fibers is between about 7% and about 16% by weight. In further embodiments, the moisture content of the cellulosic fibers is between about 8% and about 13% by weight. In yet other embodiments, the moisture content of the cellulosic fibers is about 10% by weight.

As used herein, the term “cellulose” encompasses hemicelluloses, lignocellulose and lignocellulosic fiber, containing cellulose and lignin, as well as lignin-free cellulose and refined lignocellulose. The cellulosic fiber comprises fiber derived from plant material, including plant material without lignin. For example, sources of lignin-free cellulose include, but are not limited to, cotton (not the stalk), some immature grasses, algae, seaweed, some nut shells, pulp fibers, and many ethanol production waste solids. These ethanol production waste solids may include solids from corn cobs, corn stocks, bagasse, wood and other plants with cellulose.

Lignocellulosic fiber comprises a material containing both cellulose and lignin. Suitable lignocellulosic materials may include wood particles, wood fibers, straw, hemp, sisal, cotton stalk, wheat, bamboo, jute, salt water reeds, palm fronds, flax, groundnut shells, hard woods, or soft woods, as well as fiberboards such as high density fiberboard, MDF, OSB, and particle board, and wheat straw and other bodies of annual plants that contain some lignin.

In most embodiments, the lignocellulosic fiber is refined. A selected cellulosic starting material, such as wood, may be ground or refined to prepare fibers of a substantially uniform size. For example, refined fiber may comprise wood fibers and fiber bundles that have been reduced in size from other forms of wood, such as chips and shavings. Refined wood fiber may be produced by softening the larger wood particles with steam and pressure and then mechanically grinding the wood in a refiner 102 to produce the desired fiber size. In one embodiment, the lignocellulosic fiber of the thin-layer composites comprises wood fiber.

Cellulosic fibers may be less than 0.5 inches long, although longer cellulosic fibers may be used. In some embodiments, the cellulosic fibers have an average fiber length of from about 0.03 inches (0.76 mm) to about 0.8 inches (21 mm). Other embodiments have an average fiber length of from about 0.06 inches (1.5 mm) to about 0.5 inches (13 mm). Longer cellulosic fibers may be used if, for example, jute, kenaf or similar materials are utilized.

The thin-layered composites of the present disclosure may comprise a range of cellulosic fiber compositions. Thus, in an embodiment, the final composite comprises about 60% to about 95% by weight of cellulosic fiber. In another embodiment, the final composite comprises about 70% to about 90% by weight of cellulosic fiber. In a further embodiment, the final composite comprises about 80% to about 90% by weight of cellulosic fiber. In yet another embodiment, the final composite comprises at least about 60% by weight of cellulosic fiber. In still another embodiment, the final composite comprises at least about 80% by weight of cellulosic fiber.

The prepared cellulosic fibers may be dried to a specific moisture content, and may be stored in a cellulosic fiber storage bin 104, with or without additives, until the cellulosic fibers are needed for production of the composite mixture. As used herein, the term “composite mixture” means a mixture of components used for the final composite product, but which has not yet been pressed into a final composite product.

In some embodiments, an internal release agent may be added directly to the cellulosic fibers, such as shown in optional release agent step 106. An internal release agent may be included to facilitate subsequent priming or bonding processing of the thin-layer composite. The release agent may be added directly to the cellulosic composite mixture as an internal release agent prior to refining into fibers or prior to pressing the mixture into a loose mat. The release agent may comprise an aqueous solution of compounds, monomers or polymers. For example, the release agent may comprise compounds such as, but not limited to, AQUACER™ 549 (BYK), AD9897 from Michelmann, HEXION™ 40SPM, PAT® 7299/D2 or PAT® 1667 (Wurtz GmbH & Co., Germany). Release agents that may be sprayed onto fibers prior to pressing the mixture into a loose mat comprise compounds such as, but not limited to, PB28 from SeaCole and Cellutech RA541 from Oakite. The release agent may be clear, or it may include a pigment. For example, a tinted release agent may facilitate subsequent priming or painting of the thin-layer composite.

When the release agent is added directly to the composite mixture used to form the final composite product, the amount of release agent may range from about 0.05 to about 5 weight percent of the mixture. In one embodiment, from about 0.05 to about 1 weight percent release agent is used. In another embodiment, less than about 0.35 weight percent release agent is used. For example, the release agent may be added as a solution (typically about 1% to 50% solids) and blended with the cellulosic fibers, noncellulosic fibers and resin. Adding the release agent as part of the composite mixture may require the use of more release agent than when only the surface of the composite is exposed. When the release agent is an internal release agent, it may comprise silicone or siloxane polymers. Either or both of the internal release agent and the sprayed-on release agent may include a wax.

Alternatively, the release agent may be sprayed onto a surface of a pre-compressed mat. The amount of release agent sprayed on to the mat surface may comprise from about 0.1 to about 8.0 gram per square foot (1.1 to 86.1 gram per square meter) of mat surface. In one embodiment, the amount of release agent sprayed on the mat surface may comprise less than about 1 gram per square foot (10.1 gram per square meter) of mat surface. In one embodiment, no release agent is sprayed on the mat surface. The release agent may be sprayed onto the mat as an aqueous solution of about 1%-100%. For example, an aqueous solution of about 25% release agent may be applied to the mat surface. The 100% aqueous solution may be water. When the thin-layer composite comprises a door skin, the release agent may be applied to the surface of the mat that corresponds to the surface that will become the outer surface of the door skin.

At this point, the material may be stored 104 until further processing. As shown at process step 108, the noncellulosic fibers may be added, and the cellulosic and noncellulosic fibers may then be mixed with an appropriate resin (e.g., using an atomization spray), and optionally one or more of a catalyst, a wax, a filler, a tackifier, an internal release agent and/or other additives, until a uniform composite mixture is formed. Alternatively, the resin may be added to the cellulosic fiber prior to storage of the fiber and/or prior to addition of the noncellulosic fibers.

Noncellulosic fibers may include synthetic fibers such as mineral fibers and polymer fibers. Exemplary mineral fibers include, but are not limited to glass fibers (including fiberglass), pumice fibers, lava fibers, rock wool and carbon fibers. Exemplary polymer fibers include, but are not limited to, polyester fibers, polyurethane fibers, nylon fibers, polyamide fibers, and aramid fibers. In certain embodiments, the noncellulosic fibers are glass fibers.

In some embodiments, the noncellulosic fibers are present in an amount from about 1% to about 40%, from about 3% to about 20%, or from about 5% to about 15% by weight of the total final composite product. In certain embodiments, the noncellulosic fibers are present in an amount greater than about 5% and less than about 10% by weight of the total final composite product. In other embodiments, the noncellulosic fibers are present in an amount greater than about 5% and less than about 20% by weight of the total final composite product. In still other embodiments, the noncellulosic fibers are present in an amount greater than about 5% and less than about 40% by weight of the total final composite product. In further embodiments, the noncellulosic fibers are present in an amount of about 6% by weight of the total final composite product.

In an embodiment, at least about 90% by weight of the noncellulosic fibers have a length less than about 3 inches (76 mm). In some embodiments, at least about 99% by weight of the noncellulosic fibers have a length less than about 3 inches (76 mm). In certain embodiments, at least about 90% by weight of the noncellulosic fibers may have a length less than about 1.5 inches (38 mm). In other embodiments, at least about 99% by weight of the noncellulosic fibers have a length less than about 1.5 inches (38 mm). In further embodiments, the noncellulosic fibers have an average fiber length of up to about 1 inch (25.4 mm), or of about 0.5 inches (13 mm). In other embodiments, the noncellulosic fibers have an average fiber length of between about 0.25 inches (6.3 mm) and about 0.5 inches (13 mm). In yet further embodiments, the noncellulosic fibers have an average fiber length of from about 0.03 inches (0.76 mm) to about 4 inches (102 mm), or from about 0.06 inches (1.52 mm) to about 3 inches (76 mm). In other embodiments, the noncellulosic fibers have an average fiber length of from about 0.03 inches (0.76 mm) to about 2.0 inches (51 mm) or from about 0.06 inches to about 1.5 inches (38 mm). In some embodiments, the noncellulosic fibers may have a length between about 0.1 inches (2.5 mm) and about 5 inches (127 mm). In an embodiment, the noncellulosic fibers have a length between about 0.12 inches (3 mm) and about 4 inches (102 mm). In further embodiments, the noncellulosic fibers may have a length less than about 4 inches (102 mm). In some embodiments, the noncellulosic fibers have lengths that are significantly longer than the lengths of the cellulosic fibers.

The noncellulosic fibers may have a diameter greater than about 3.0 microns (0.003 mm). In some embodiments, the noncellulosic fibers have a diameter of less than about 100 microns (0.1 mm). In certain embodiments, the noncellulosic fiber has a diameter within the range of about 14 to about 18 microns (0.014 to 0.018 mm).

The thin-layer composites of the present disclosure have a high resistance to moisture-induced shrinkage and swelling. As used herein, a normal moisture level of a final composite product typically ranges between 4% and 9%. A normal moisture level of a composite mixture typically ranges between 7% and 16%. Moisture contents below this range may be considered low moisture, and moisture contents above this range may be considered high moisture.

It is believed that swelling and/or shrinking of wood is, at least partially, the result of water reacting with hydroxyl groups present in cellulose and hemicelluloses. Thus, high moisture levels increase the amount of water bound to the wood fiber. Alternatively, in low humidity, water is lost from the wood fibers. Wood may be treated with chemical agents to modify the hydroxyl groups present in the cellulose and to thereby reduce the reactivity of cellulose fibers with water. For example, acetylation of cellulose fibers can reduce the number of hydroxyl groups available to interact with water and thus, make the fibers less susceptible to heat-induced drying or moisture-induced swelling. On a large scale, acetylation may not be commercially viable as it is expensive to acetylate wood.

The present disclosure provides methods to employ isocyanate resins to improve the moisture-resistance of thin-layer cellulosic composites, such as wood door skins. Isocyanate resins such as diphenylmethane-4,4′-diisocyanate (MDI) and toluene diisocyanate (TDI) resin are highly effective in modifying the reactive groups present on cellulose fibers to thereby prevent the fibers from reacting with water. It is believed that the isocyanate forms a chemical bond between the hydroxyl groups of the wood cellulose and hemicelluloses, thus forming a urethane and/or polyurea linkage.

Another advantage of using isocyanate resins rather than formaldehyde crosslinked resins is that less energy is needed to dry the wood fiber prior to pressing the mat. Traditional phenol-formaldehyde resins are generally not compatible with wood having a water content greater than about 8%, as the water tends to interfere with the curing process. Excess moisture in the wood fiber may also cause blistering when pressed with melamine-formaldehyde resins or urea-formaldehyde resins. Thus in conventional methods, for wood having a moisture content of greater than about 8%, the wood must be dried for the curing step, and then re-hydrated later. In contrast, isocyanate-based resins are compatible with wood having a higher water content and thus, curing with isocyanate-based resins may obviate the need for the drying and the re-hydrating steps associated with formaldehyde-based resins.

In some embodiments, the resin is an isocyanate resin, and may be an organic isocyanate resin. The organic isocyanate resin used may be aliphatic, cycloaliphatic, or aromatic, or a combination thereof. Monomeric or polymeric isocyanates may be used. In an embodiment, the isocyanate may comprise diphenylmethane diisocyanate (MDI) or toluene diisocyanate (TDI) such as Lupranate®M2OFB Isocyanate (BASF Corporation, Wyandotte, Mich.) or RUBINATE™ 1840 (Huntsman Chemical, The Woodlands, Tex.). For example, in an embodiment, the isocyanate comprises diphenylmethane-4,4′-diisocyanate. In certain embodiments, the isocyanate may be selected from the group consisting of toluene-2,4-diisocyanate; toluene-2,6-diisocyanate; isophorone diisocyanate; diphenylmethane-4,4′-diisocyanate; 3,3′-dimethyldiphenylmethane-4,4′-diisocyanate; m-phenylene diisocyanate; p-phenylene diisocyanate; chlorophenylene diisocyanate; toluene-2,4,6-triisocyanate; 4,4′,4″-triphenylmethane triisocyanate; diphenyl ether 2,4,4′-triisocyanate; hexamethylene-1,6-diisocyanate; tetramethylene-1,4-diisocyanate, cyclohexane-1,4-diisocyanate; naphthalene-1,5-diisocyanate; 1-methoxyphenyl-2,4-diisocyanate; 4,4′-biphenylene diisocyanate; 3,3′-dimethoxy-4,4′-biphenyl diisocyanate; 3,3′-dimethyl-4,4′-biphenyl diisocyanate; 4,4′-dimethyldiphenylmethane-2,2′,5,5′-tetraisocyanate; 3,3′-dichlorophenyl-4,4′-diisocyanate; 2,2′,5,5′-tetrachlorodiphenyl-4,4′-diisocyanate; trimethylhexamethylene diisocyanate; m-xylene diisocyanate; polymethylene polyphenylisocyanates; and mixtures thereof.

Commercial preparations of the isocyanate resin material may contain not only 4,4′-methylene diphenyl diisocyanate, but also poly(methylene diphenyl diisocyanate) otherwise known as polymeric MDI (or pMDI), mixed methylene diphenyl diisocyanate isomers, and 2,4′-methylene diphenyl diisocyanate. Commercially available preparations of 4,4′-methylene diphenyl diisocyanate give thin-layer composites of high consistency when used as described herein.

The isocyanate resin may comprise a resin with thermoset properties. When reagents used for the resin are mixed at the required ratio, an exothermic reaction occurs to irreversibly form the thermoset. Thermoset resins provide increased resistance to temperature fluctuations, such as in climates prone to high temperatures, when compared to non-thermoset resins, as thermoset resins typically do not soften and lose strength thereby.

A range of isocyanate resin levels may be used to make the thin-layer composites of the present disclosure. Thus, in an embodiment, the final composite may comprise from about 1% to about 15% by weight resin. In further embodiments, the final composite may comprise from about 5% to about 10% by weight resin. In still further embodiments, the final composite may comprise less than about 20% by weight resin. In other embodiments, the final composite may comprise at least about 1% by weight resin, or at least about 5% by weight resin. In still other embodiments, the isocyanate resin may be present in a weight percentage between about 3% and about 8%.

In some embodiments, it may be desirable to add a catalyst to the present composites, which may result in one or more of faster resin cure and shorter press times, improved moisture resistance, and improved release of the thin layer composite from the dies. Exemplary catalysts contemplated as useful in accordance with this disclosure may include one or more of petroleum based polyols, amines, bio-based polyols, or similar catalysts. An example of a polyol catalyst is a wood product accelerant (e.g., WPA 25010) available from Huntsman Corporation. Where utilized, the catalyst may be added to the composite mixture in an amount from about 0% to about 30%, based on resin weight; further embodiments, from about 10% to about 20% based on resin weight; in still further embodiments, from about 13% to about 17% based on resin weight. For example, about 1% by weight of polyol may be added, based on the weight of the door skin.

In some embodiments, the resin adheres to the cellulosic and noncellulosic fibers. A sizing agent may be applied in order to protect the fibers from absorbing water. When a sizing agent is applied to the noncellulosic fibers, the resin may adhere to the sizing agent. In one embodiment, silane is used as a sizing agent. The present composites may further comprise fillers. Fillers contemplated as useful may include one or more of pumice, shale, talc, calcium carbonate, glass flakes, aluminum trihydrate, borate, calcium sulfate, clay and/or other minerals. Where utilized, the fillers may be present in the composites in an amount from about 1% to about 30% by weight. In some embodiments, the fillers may be present in the composites in an amount from about 5% to about 20% by weight. The fillers may be mixed with the cellulosic fibers, the resin, and/or the noncellulosic fibers prior to, during, or after pressing. The fillers may be sized or un-sized.

In some embodiments, colorants may be introduced to the composites. The colorant may be mixed with the other ingredients prior to, during, and/or after pressing. Suitable colorants include titanium dioxide, manganese dioxide, carbon black, or other appropriate pigments known in the art. For example, in one embodiment, the release agent may comprise a pigment. In this way, an even coloring is applied to the thin-layered cellulosic composite.

With reference to FIG. 1, the mixture may then be formed by former 110 into a loose mat which may be modified to the desired thickness using a shave-off roller 112 and pre-compressed by a roller 116 or another pressing mechanism to a density of about 3 to about 12 pounds per cubic foot. After further trimming to the correct length and width with a trimmer, for example, a flying saw, a release agent may optionally be applied to the top surface of the mat segments. The pre-pressed mat segments may be introduced into a platen press, and compressed between two dies under conditions of increased temperature and pressure. For example, in one embodiment, pressing conditions may comprise pressing the mat for about 15 seconds between dies heated to about 300° F. (about 149° C.), and compressing via hydraulic rams below the dies, which are set to a pressure in the range of about 600-800 psi (about 42.2-59.8 kg/cm²), followed by about 30 seconds of a lower applied pressure of about 100-300 psi (about 7-21.1 kg/cm²). In another embodiment, the rams may be above the dies and may close under gravitational force, and then may be set to a pressure in the range of about 1000-2000 psi (about 70.3-140.6 kg/cm²), for example, between about 1400-1600 psi (about 98.5-112.5 kg/cm²). In some embodiments, the mat may be pressed to a desired thickness due to the presence of stops in the pressing mechanism.

In some embodiments, the dies are heated to a higher temperature of approximately 400° F. or more, to accelerate the curing process. Generally, a recessed (female) die is used to produce the inner surface of the door skin (facing the door frame or core), and a male die shaped as the mirror image of the female die is used to produce the outside surface of the skin. The dies may include surface contours to create a paneled appearance and simulated sticking in the door skin. In some embodiments, the male die may include a surface texture that forms a wood grain pattern in the surface of the door skin. After pressing, the resulting door skin is removed from the press, cooled and optionally sized, primed and humidified. The resulting thin-layer composite door skin is mounted into a door frame or core using an adhesive and employing methods well known in the art.

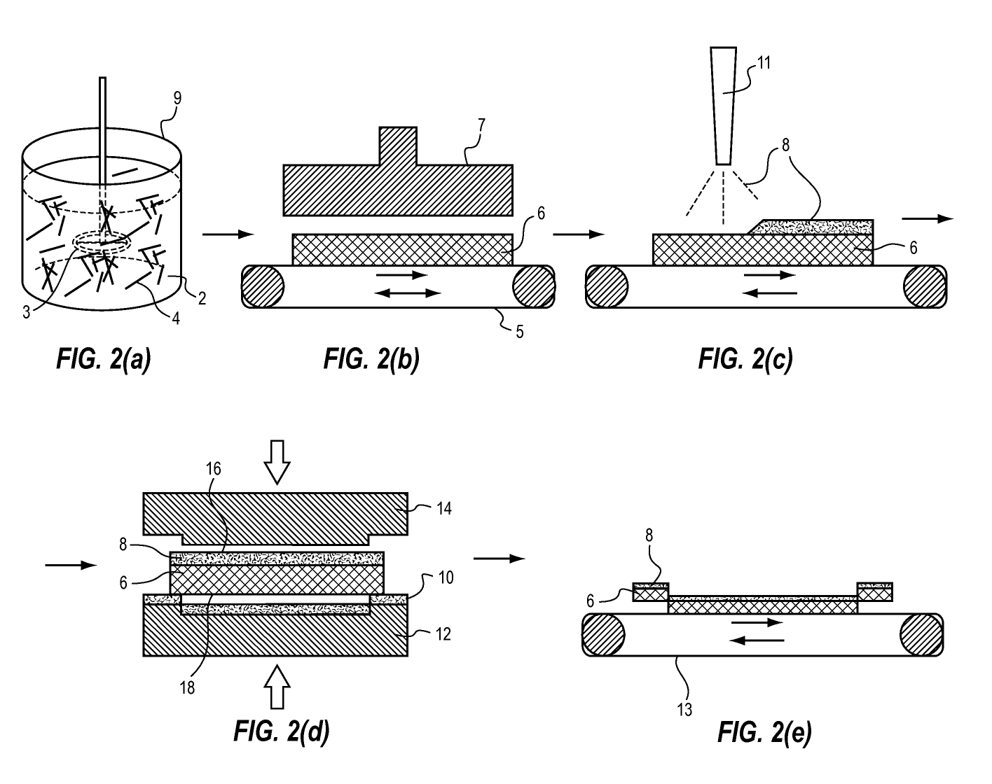

FIGS. 2(a)-2(e) illustrate individual steps in an exemplary method for making a thin-layer composite product. With reference to FIG. 2(a), the present disclosure describes a method for making a thin-layer composite product comprising forming a composite mixture 2 comprising: (i) a refined cellulosic fiber 4; (ii) at least about 1% by weight noncellulosic fibers; and (iii) at least about 1% by weight of an organic isocyanate resin. Optionally, an internal release agent, catalyst, wax, tackifiers, fillers and/or additives may be added to the mixture 2. In some embodiments, the mixture 2 may be prepared using blowline blending of the resin, fibers, and any other ingredients. Alternatively, a blender 9 having a means for mixing 3 such as a paddle, devil-toothed plates, fluted plates, attrition plates, fluted plates, refining plates, or the like, may be used. The cellulosic and noncellulosic fibers, resin, and other components may be mixed in the blender 9 for a set time until the composite mixture is uniform. The uniform mixture is then conveyed to a former box 110 (see FIG. 1). The mixture may be conveyed by mechanical means, dropped by gravity, or carried by positive pressure or vacuum suction out of the blender 9 and to the former box 110. The former box 110 may shape the composite mixture into a loose mat on the surface of a moving conveyor belt 5.

The loose mat may be modified to the desired thickness by using a shaver 112 (see FIG. 1). In some embodiments, the shaver 112 is a shave-off roller. The shave-off roller may have small teeth or bristles that help convey excess material to a recycling loop 114. Without being tied to theory, the teeth or bristles may also help to align cellulosic or noncellulosic fibers on or near the surface of the mat to lie generally parallel to the plane of the surface of the mat. The presence of aligned noncellulosic fibers appears to facilitate alignment of the cellulosic fibers and reduce the incidence of cellulosic fibers having a lengthwise orientation that is transverse to the plane of the surface of the final composite product.

With reference to FIG. 2(b), the loose mat composite mixture may be pre-pressed to reduce its thickness by between about 40% and about 70% to form a pre-compressed mat 6. The pre-pressing compression may be achieved by a roller 116 (FIG. 1) or belt (not shown) mounted at a fixed distance above a conveyor belt 5 that transports the mat between equipment stations, or by some other type of press 7, illustrated schematically in FIG. 2(b). The density of the compressed mat 6 may vary depending on the nature of the wood composite being formed, but generally, the mat is formed and compressed to have a density of about 3 to about 12 pounds per cubic foot (i.e. 48-192 kg per cubic meter).

With reference to FIG. 2(c), after trimming the pre-compressed mat 6 into segments sized to fit the press dies 12 and 14 (see FIG. 2(d)), an optional release agent 8 may be applied to a surface of the mat 6 by spraying the release agent onto a surface of the mat 6 using a spinning disc spray nozzle applicator, or other applicator 11. In an embodiment, the release agent 8 comprises an aqueous solution of compounds, monomers or polymers.

With reference to FIG. 2(d), the mat 6 may then be loaded into a press between a male die 14 and a female die 12, and pressed at an elevated temperature and pressure and for a sufficient time to further reduce the thickness of the loose mat composite mixture and to allow the isocyanate resin to interact with the fibers. As described above, it is believed that by heating the composite in the presence of the resin, the isocyanate of the resin forms a urethane or polyurea linkage with the hydroxyl groups of the cellulose.

The conditions used to form the thin-layer composite products include compressing the mixture at an elevated temperature and pressure for sufficient time to allow the isocyanate resin to interact with the cellulosic and noncellulosic fibers such that the resultant thin-layer composite has a resistance to moisture. The exact conditions used will depend upon the equipment used, the resin used, the exterior environment (e.g., temperature, relative humidity, elevation), the manufacturing schedule, the cost of input resources (e.g., starting materials, electric power), and the like. Varying the temperature may allow for changes to be made in the pressure used or the time of pressing; similarly, changes in pressure may require adjustment of the time and/or temperature used for pressing the thin-layer composites of this disclosure. For example, using a toluene diisocyanate (TDI) resin as opposed to diphenylmethane diisocyanate (MDI) resin may shorten the press time by as much as about 10%. Generally, when using isocyanate resins, very high temperatures are not required; thus, isocyanate resins may be associated with decreased energy costs.

A range of temperatures may be used to promote interaction of the isocyanate resin with the cellulosic fibers in the composite mixture. In an embodiment, the temperature used to press the mixture (or loose mat composite mixture) into a thin-layer composite may range from about 250° F. (121° C.) to about 400° F. (204° C.). In another embodiment, the temperature used to press the mixture (or loose mat composite mixture) into a thin-layer composite may range from about 270° F. (132° C.) to about 370° F. (188° C.). In a further embodiment, a temperature that is in the range of from about 290° F. (144° C.) to about 350° F. (177° C.) may be used.

Depending upon the selected temperature and pressure conditions used for pressing, the total pressing time may range from about 30 seconds to about 5 minutes or more. Thus, in an embodiment, the pressure of the rams during the pressing step may range from about 2500 psi (176 kg/cm²) to about 100 psi (7 kg/cm²). In another embodiment, the pressure may be applied in a step-wise manner. In some embodiments, the pressure of the rams used to press the loose mat composite mixture into a thin layer is within a range from about 2500 psi (about 176 kg/cm²) to about 1000 psi (about 70.3 kg/cm²) for about 5 to about 30 seconds, followed by a second lower pressure within a range from about 800 psi (about 56.2 kg/cm²) to about 300 psi (about 21.1 kg/cm²) for about 10 to about 80 seconds. In certain embodiments, the pressure of the rams used to press the loose mat composite mixture into a thin layer is within a range from about 2000 psi (about 140.6 kg/cm²) to about 1100 psi (about 77.3 kg/cm²) for about 5 to about 30 seconds, followed by a second lower pressure within a range from about 600 psi (about 42.2 kg/cm²) to about 400 psi (about 28.1 kg/cm²) for about 10 to about 80 seconds. In a further embodiment, the pressure of the rams during the pressing step ranges from about 1200 psi (84.3 kg/cm²) for about 5 to about 30 seconds, followed by 500 psi (35.16 kg/cm²) for about 10 to about 80 seconds. For example, in still further embodiments, the pressure of the rams during the pressure step ranges from about 1200 psi (84.3 kg/cm²) for about 10 seconds to about 500 psi (35.16 kg/cm²) for about 50 seconds.

With reference to FIG. 2(e), upon curing of the resin, a door skin 16 having a resistance to moisture is formed. The door skin is removed from the dies 12 and 14, conveyed by payoff conveyor 13 and allowed to cool while transporting for further processing (sizing, priming and/or humidifying) prior to being assembled into a completed door.

In certain embodiments, one or both of the dies may be coated with an anti-bonding agent. FIG. 2(d) shows an embodiment in which the female die 12 is coated on its inner surface with an anti-bonding agent 10. As used herein, the term “anti-bonding agent” refers to a composition disposed on one or more of the manufacturing dies that is effective in inhibiting the composite from adhering to the dies. In an embodiment, coating the die may comprise baking the anti-bonding agent onto the die surface.

In an embodiment, the anti-bonding agent comprises silica, silane or silicone. Thus, the anti-bonding agent may comprise anti-bonding agents known in the art of die pressing such as CrystalCoat MP-313 and Silvue Coating (SDC Coatings, Anaheim, Calif.), Iso-Strip-23 Release Coating (ICI Polyurethanes, West Deptford, N.J.), aminoethylaminopropyl-trimethoxysilane (Dow Corning Corporation), or 7004W (Chemtrend, Howell, Mich.).

For certain embodiments, the die that is coated with the anti-bonding agent may correspond to the die used to press the outside surface of the door skin. In one embodiment, the amount of anti-bonding agent used may range in thickness from about 0.0005 to about 0.010 inches (i.e., about 0.0127 mm to about 0.254 mm). In an embodiment, the amount of anti-bonding agent used comprises a thickness of about 0.003 inches (i.e., about 0.0762 mm).

In one embodiment, coating the die comprises baking the anti-bonding agent onto the die surface. For example, in certain embodiments, the step of baking the anti-bonding agent onto the die surface may comprise: (i) cleaning the die surface free of all contaminants, such as dirt, dust and grease; (ii) spraying from about 0.0005 to about 0.010 inches (about 0.5 to about 10 mils or about 0.0127 to about 0.254 mm) of a 50% solution of the anti-bonding agent onto the die; and (iii) baking the die at greater than about 280° F. (about 138° C.) for about 1 to about 4 hours. An adhesion promoter, or primer, may be applied to the die surface prior to application of the anti-bonding agent. In one embodiment, an anti-bonding agent is coated onto the bottom (female) die. In certain embodiments, the anti-bonding agent may be re-applied to the die while it is in the press without cleaning or heating.

In further embodiments, the step of cleaning the die comprises cleaning the die surface with a degreaser, soda or high-pressure water; wire brushing to remove solids; wiping the die surface with a solvent (such as acetone); and buffing with a cotton pad. The anti-bonding agent may then be applied in multiple layers to provide, for example, a 3 mil thickness, and the dies heated to bake the coating onto the die.

Under suitable conditions, the anti-bonding agent that is baked onto the die (or dies) may be stable enough to the pressing conditions such that the die(s) can be used for over 2000 pressing cycles prior to requiring a second coating with additional anti-bonding agent.

Additional embodiments of anti-bonding agents that facilitate release of the door skin from the die(s) include nickel or chrome plating, a ceramic layer, or fluorocarbon coating to prevent bonding of the resin to the die.

In an embodiment, this disclosure comprises a method to produce a thin-layer composite having high water resistance comprising: (a) forming a composite mixture comprising: (i) a refined cellulosic fiber optionally comprising a moisture content of between about 7% and about 20% by weight; (ii) at least about 1% by weight of noncellulosic fibers; (iii) at least about 1% by weight of an organic isocyanate resin; and (iv) optionally, a release agent; (b) pressing the composite mixture into a loose mat; (c) optionally, spraying at least one surface of the loose mat composite mixture with a release agent; and (d) pressing the loose mat composite mixture between two dies at an elevated temperature and pressure and for a sufficient time to further reduce the thickness of the mat to form a final thin-layer composite product and to allow the isocyanate resin to interact with the wood fibers and noncellulosic fibers such that the door skin has a resistance to moisture, wherein at least one of the die surfaces has optionally been coated with an anti-bonding agent.

The internal release agent may include wax. Thus, certain embodiments may include at least one type of wax added to the cellulosic material before or after storage. For example, the mixture may comprise up to about 2% by weight of wax. In some embodiments, the range is from about 0.1% to about 1.0% of the final composite product. In a certain embodiment, about 0.5% by weight wax is used. In another embodiment, about 0.8% by weight wax is used.

The wax may impart short-term water repellency to the cellulosic composite. The type of wax used is not particularly limited, and waxes standard in the art of wood fiber processing may be used. Generally, the wax should be compatible with the temperatures used for pressing the wood/resin mixture into a thin layer, increase the water repellency of the wood, and not adversely affect the aesthetics or subsequent processing (such as priming or gluing) of the composite. Thus, the wax may be a natural wax or a synthetic wax, generally having a melting point in the range of about 120° F. (49° C.) to about 180° F. (82° C.). Waxes used may include, but are not limited to, paraffin wax, polyethylene wax, polyoxyethylene wax, microcrystalline wax, shellac wax, ozokerite wax, montan wax, emulsified wax, slack wax, and combinations thereof.

In another embodiment, the mixture is substantially free of added wax. As used herein, the term “added wax” includes wax added to the mixture as a distinct component. Similarly, as used herein, “substantially free of added wax” includes composites having no wax, as well as composites having a negligible amount of wax at concentrations that would not materially affect the composites, or where the wax is a part of a different component of the mixture, for example a tackifier and/or release agent. When wax is included as a part of the recited components and the mixture is substantially free of wax, this means that the wax is present in amounts that do not have a measurable effect on the physical characteristics of the present final thin-layer composite products. For example, a composite having less than about 0.1% wax may be encompassed by the term “substantially free of added wax.” In some embodiments, the composite is free of added wax. In additional embodiments, various components, such as, for example, the release agent may include certain amounts of wax. Embodiments in which the release agent includes wax, but no other wax is added, are considered to be “substantially free of added wax.”

In some embodiments, the mixture is free of wax.

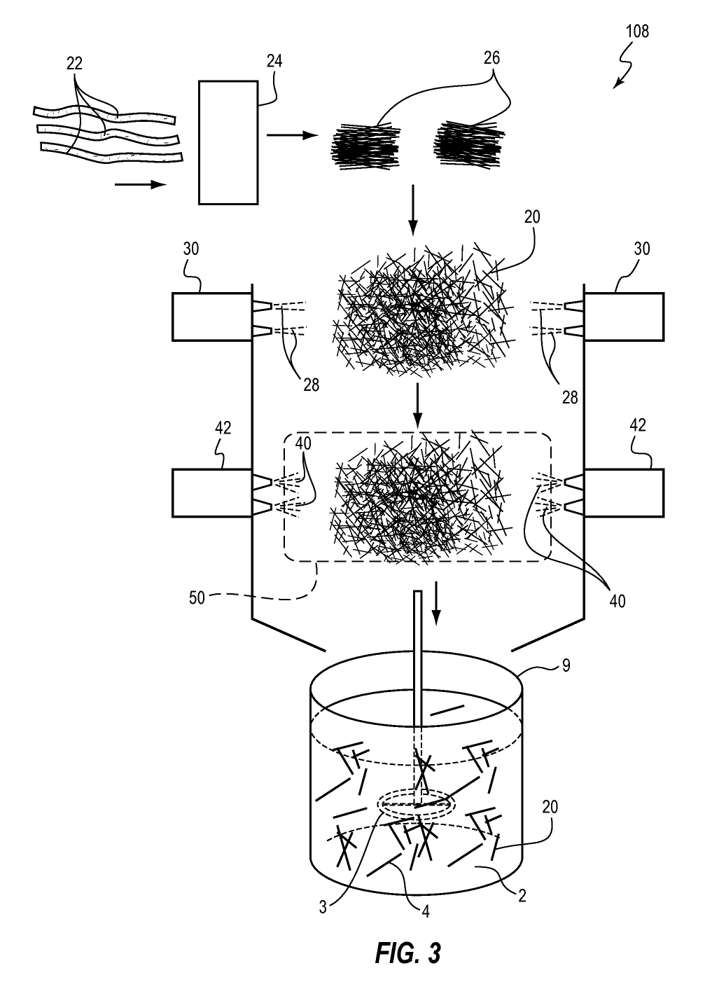

With reference to FIG. 3, the noncellulosic fiber filaments 20 may be obtained by milling, breaking, or chopping strands to a desired length as, or after, the noncellulosic fibers are produced. Alternatively, the noncellulosic fibers are formed into bundles, strands, or rovings 22 by the fiber manufacturer and chopped or otherwise sized to a desired length. As shown in a process step 24, the strands or rovings 22 may be ground or cut, such as by milling, chopping, or breaking, at desired intervals to obtain bundles 26 of noncellulosic fibers having desired lengths. Depending on the process, the fibers may all have the same length or the fibers may have varying lengths. For example, cutting fibers from woven strands may produce fibers with length variations due to the twisting or winding variation in the roves. In some embodiments, it may be desirable to have a small or large variation in the lengths of the fibers. In further embodiments, the bundles may be cut from strands. The noncellulosic fibers may be separated into individualized noncellulosic fibers or noncellulosic fiber filaments 20.

In some embodiments, the noncellulosic fibers may be individualized. The term “individualized fibers” means fibers which have been separated into individual filaments. For example, individualized fibers are fibers that have been separated such that they are generally not coextensive with, or touching, each other. In certain embodiments, individualized noncellulosic fibers are not clumped together in bundles of more than ten noncellulosic fibers.

In some embodiments, one way to characterize individualized noncellulosic fibers is by evaluating the amount of coextensivity of the fibers. In some embodiments, individualized noncellulosic fibers are noncellulosic fibers that are touching each other along less than 25% of their lengths. In other embodiments, individualized noncellulosic fibers are noncellulosic fibers that are touching each other along less than 15% of their lengths. In further embodiments, individualized noncellulosic fibers are noncellulosic fibers that are touching each other along less than 10% of their lengths. In still further embodiments, individualized noncellulosic fibers are noncellulosic fibers that are touching each other along less than 5% of their lengths. In certain embodiments, individualized noncellulosic fibers are noncellulosic fibers that are touching each other along less than 2% of their lengths.

In some embodiments, greater than 65% of the noncellulosic fibers are individualized fibers. In further embodiments, greater than 75% of the noncellulosic fibers are individualized fibers. In yet further embodiments, greater than 80% of the noncellulosic fibers are individualized fibers. In certain embodiments, greater than 85% of the noncellulosic fibers are individualized fibers. In still further embodiments, greater than 95% of the noncellulosic fibers are individualized fibers. In additional embodiments, greater than 98% of the noncellulosic fibers are individualized fibers.

Each of these percentages of individualized noncellulosic fibers may be combined with each of the percentages concerning the degrees of touching, to obtain separate embodiments. For example, in some embodiments, greater than 65% of the noncellulosic fibers may be touching each other along less than 25% of their lengths, or greater than 98% of the noncellulosic fibers may be touching each other along less than 2% of their lengths, or any variation in between. These percentages are not intended to limit the claim scope, unless expressly identified as such in a claim.

In some embodiments, less than 35% of the noncellulosic fibers are in groups of more than ten noncellulosic fibers that are touching each other by more than 5% along their lengths. In further embodiments, less than 25% of the noncellulosic fibers are in groups of more than ten noncellulosic fibers that are touching each other by more than 5% along their lengths. In still further embodiments, less than 15% of the noncellulosic fibers are in groups of more than ten noncellulosic fibers that are touching each other by more than 5% along their lengths. In certain embodiments, less than 10% of the noncellulosic fibers are in groups of more than ten noncellulosic fibers that are touching each other by more than 5% along their lengths.

With reference to FIG. 3, groups 26 of noncellulosic fibers may be separated, dispersed, and/or individualized by chopping or cutting, near or above the mixing chamber or blender 9 and separated, dispersed, and/or individualized by one or more streams of a gas 28, such as air. The streams of gas 28 may also be used to individualize fibers that have been partially separated or dispersed by mechanical means.

The streams of gas 28 may be provided by one or more separated nozzles 30, one or more separated rows or columns of nozzles 30, an array of separated nozzles 30, or an integrated array of nozzles 30. The nozzles 30 may form a perimeter to contain the flow of individualized noncellulosic fibers 20 within a desired volume of air space. Alternatively, the nozzles 30 may be arranged to have a particular position with respect to the flow of the chopped groups 26. Skilled persons will appreciate that numerous positioning arrangements of nozzles 30 are possible and may depend on variables such as the distance of the chopping apparatus in the process step 24 from the blender 9, the rate of fiber being chopped, the diameter of the rovings 22, the number of nozzles 30, the flow rate of gas, or many other factors. Similarly, the nozzles 30 may be oriented to provide streams of gas 28 that are orthogonal to the flow path of the chopped groups 26 or may provide one or more orientations that are transverse to the flow path of the chopped groups 26 in a manner that facilitates individualization of the noncellulosic fibers. The orientations of the nozzles 30 may be subject to the positioning of the nozzles 30 as well as any of the same variables associated with the positioning of the nozzles 30. The position and orientation of the nozzles 30 may be fixed or the position and orientation of the nozzles 30 may be adjusted by actuators under computer control.

The streams of gas 28 may be applied at the same rate from all of the nozzles 30 or at different rates from different nozzles 30. The flow rate of the gas 30 may be continuous at a constant rate, continuous at a varied rate, or pulsed at regular or variable rates. The flow rates of the gas 28 may be controlled by a computer.

In some embodiments, the gas may be a pure gas, such as nitrogen or a noble or a de-ionized gas. In other embodiments, a gas mixture such as air or de-ionized air may be used. A fiber-individualizing step may be performed in a special containment chamber (not shown) or may be exposed to ambient conditions.

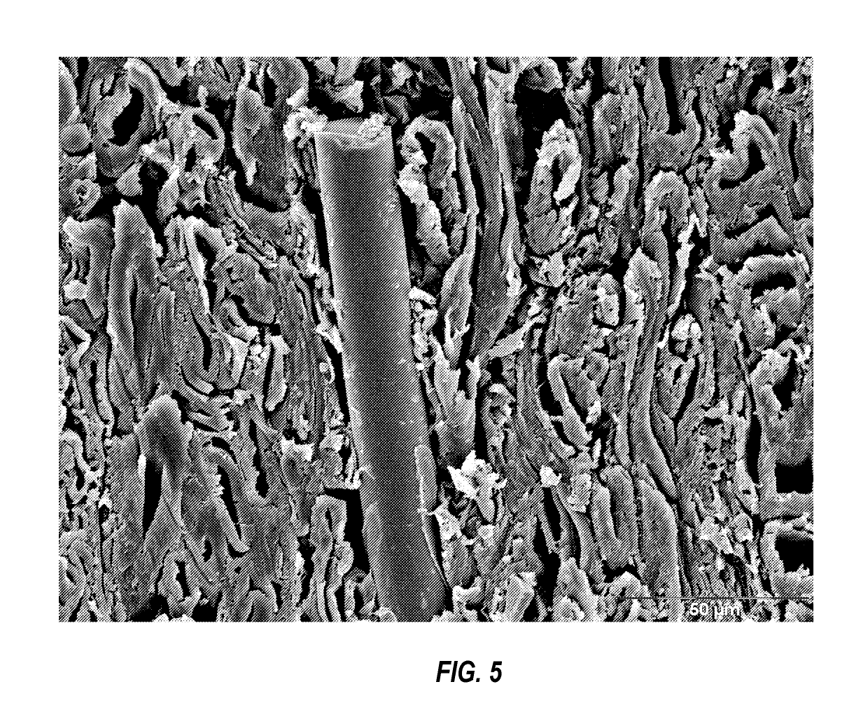

The groups 26 of noncellulosic fibers may be separated or individualized through mechanical means, such as by submerging the bundles in water and agitating the mixture to separate the fibers into individual filaments, then draining the water and drying the filaments. Alternatively or additionally, the groups 26 of noncellulosic fibers may be separated or individualized by rollers or by passage through one or more pairs of relatively rotating fiber refiner plates (also known as devil-toothed plates or maze plates). The fiber refiner plates may be separate from and precede the blender 9, or they may constitute the blender 9. An SEM micrograph of an exemplary thin-layer composite product containing individualized noncellulosic fibers is shown in FIG. 5.

In some embodiments, less than three bundles containing ten or more contacting noncellulosic fibers are visible on the surface of a 20-square foot door skin. Bundles containing multiple contacting noncellulosic fibers may be visually unacceptable on an exterior surface (as opposed to an interior surface that may be bound to a core of a door, for example) of the final composite product. Some of the noncellulosic fibers within the interior of such a bundle may be blocked from coming in contact with or bonding with resin particles. Such unbound noncellulosic fibers at the surface of a final composite product may in some cases be relatively easy to pull out of the composite. Generally, in bundles containing ten or fewer noncellulosic fibers, each noncellulosic fiber should have an opportunity to contact and bond with the resin. However, an acceptable number of noncellulosic fibers in a bundle in the context of bonding may depend on numerous factors including the diameter of the fibers, the type of resin, other components in the mixture, and the process conditions. For example, composites made from mixtures having resin content above 20% may permit very high numbers of noncellulosic fibers in a bundle or may be relatively unaffected by the presence of bundles.

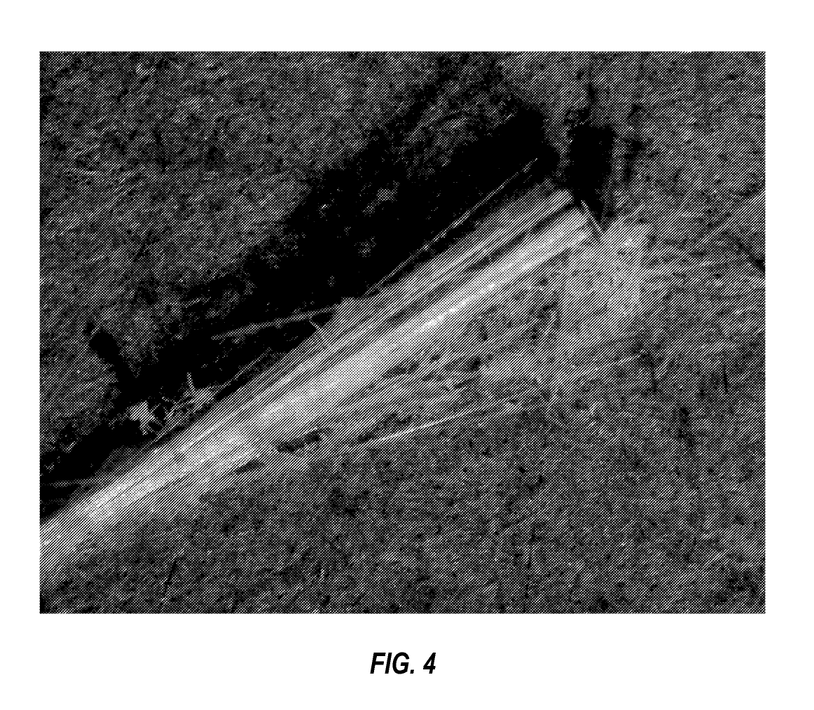

A bundle of noncellulosic fibers that is protruding from the exterior of a final composite product is visible in the photograph of FIG. 4 (see Example 3). As shown in FIG. 4, a bundle of noncellulosic fiberglass fibers is visible in a magnified photograph (60×) of a door skin. No resin is able to get into the fibers in the center of the bundle, which will allow the fibers to break free over time and cause a defect on the surface of the thin-layer composite.

An exemplary test to determine the number of bundles having more than ten noncellulosic fibers may utilize a 60×microscope to review a two square inch surface area of the exterior surface of the composite for every one square foot of exterior surface area of the composite. In some tests, the exterior surface area of the composite may be divided into three sections, and the test squares are spatially distributed within the sections. The tests may be performed on unprimed or uncoated composites. Composites that have been primed or coated can be sanded to remove the primer or coating prior to examination. In an alternative backside test, 0.015 inches or 0.020 inches can be sanded from the interior surface (the surface used for bonding to a core of a door) and the resulting backside surface can be similarly evaluated with a microscope.

An additional exemplary test to determine the number of ends of cellulosic fiber that protrude from the exterior surface can be established by examining twenty 0.5-inch squares from flat portions (i.e. not intentionally contoured) of the exterior surface with a 120×microscope. The 0.5-inch test sections may be randomly selected to be representative of the flat portions of the exterior surface. The protrusions are counted with respect to the plane of the exterior surface of the flat portion selected. The number of protruding ends of cellulosic fibers can be similarly evaluated.

In some embodiments, the majority of cellulosic fibers at or contacting the surface of the composite (prior to priming the composite, in certain embodiments) have ends protruding from the exterior surface at an angle less than 45, 30, 15, or 5 degrees with respect to the plane of the surface of the composite. In further embodiments, the majority of cellulosic fibers at or contacting the surface of the composite (prior to priming the composite, in certain embodiments) have ends protruding from the exterior surface at an angle that is generally parallel to the plane of the surface of the composite.

In some embodiments, a reduction in the number of ends of noncellulosic fibers protruding per square inch of the flat portions (i.e. not intentionally contoured) of the exterior surface of the final composite product, may enhance certain properties of the composite. Such reduction may be useful in embodiments of composite surfaces that cannot be sanded, for example, such as those of a simulated woodgrain. In certain embodiments, less than 1000 ends of noncellulosic fibers protrude per square inch of the exterior surface of the composite by more than ten times the diameter of the noncellulosic fiber. In further embodiments, less than 500 ends of noncellulosic fibers protrude per square inch of the exterior surface of the composite by more than ten times the diameter of the noncellulosic fiber. In still further embodiments, less than 100 ends of noncellulosic fibers protrude per square inch of the exterior surface of the composite by more than ten times the diameter of the noncellulosic fiber. In additional embodiments, less than 50 ends of noncellulosic fibers protrude per square inch of the exterior surface of the composite by more than ten times the diameter of the noncellulosic fiber. In some of these embodiments, less than 1000, 500, 100, or 50 ends of noncellulosic fibers protrude per square inch of the exterior surface of the composite by more than five times or by more than three times the diameter of the noncellulosic fiber. In some of these embodiments, less than 1000, 500, 100, or 50 ends of noncellulosic fibers protrude per square inch of the exterior surface of the composite by more than 0.005 inches or by more than 0.0005 inches. The protrusion of fibers may be prevented by, for example, reducing the amount of noncellulosic fibers used or by cutting the noncellulosic fibers to a shorter length.

With reference to FIG. 3, in some embodiments, the resin is added by an atomizing spray process to facilitate increased contact area between the resin and the fibers, including at least one of cellulosic fibers and noncellulosic fibers. In certain embodiments, a resin spray 40 is a fine mist delivered through an atomizing spray nozzle 42. The atomizing spray nozzle may be a hydraulic spray-type nozzle, a gas spray-type nozzle, or an ultrasonic nozzle. In some additional embodiments, the noncellulosic fiber filaments 20 pass or continue through a gas-medium interaction zone 50 to facilitate or maximize contact between the resin spray and the noncellulosic fiber filaments 20. The noncellulosic fibers may be introduced into the gas-medium interaction zone 50 before, after, or at about the same relative position as the resin. In some embodiments, the gas-medium interaction zone 50 precedes the blender 9.

Composites made by the method of this disclosure may comprise significantly less linear expansion and swelling than composites made by conventional methods. Thus, door skins made by the methods disclosed may exhibit about 50% less linear expansion and thickness swelling than non-isocyanate based door skins when immersed in water for about 24 hours at about 70° F. (about 21.1° C.), a standard test used in the industry (ASTM D1037), than a thin-layer composite comprising comparable levels of an alternate (non-isocyanate) resin with no noncellulosic fibers. For example, door skins made with a 6% melamine-urea-formaldehyde resin swell in a range from about 20% to about 50% when immersed in water for about 24 hours at about 70° F. In contrast, door skins made by the methods disclosed herein using an isocyanate resin swell in a range between about 5% to about 25% under the same conditions. In other embodiments, door skins made by the methods disclosed herein using an isocyanate resin swell in a range between about 10% to about 20%. In further embodiments, door skins made by the methods disclosed herein using an isocyanate resin may swell an average of about 15%.

In one embodiment, door skins made by the disclosed methods may be significantly less dense than door skins made using traditional formaldehyde-based resins. For a door skin that is about 0.12 inches (about 3.05 mm) thick and contains about 10% melamine-urea-formaldehyde resin and about 1.5% wax, the density is about 58 pounds per cubic foot (about 930 kg/m³). In contrast, door skins disclosed herein may have a density as low as about 47 pounds per cubic foot (about 754 kg/m³). In some embodiments, the thin-layer composites disclosed herein may comprise a density of less than about 60 pounds per cubic foot (about 962 kg/m³). In further embodiments, the thin-layer composites disclosed herein may comprise a density of less than about 55 pounds per cubic foot (about 881.5 kg/m³). In additional embodiments, the thin-layer composites disclosed herein may comprise a density of less than about 55 pounds per cubic foot (about 881.5 kg/m³).

In certain embodiments, the thin-layer composite thickness ranges from about 0.050 inches to about 0.625 inches (about 1.27 mm to about 15.88 mm). In further embodiments, the thickness of the thin-layer composite may range from about 0.105 to about 0.130 inches (about 2.67 to about 3.30 mm). In other embodiments, the thickness ranges from about 0.03 inches to about 0.19 inches (about 1 mm to about 5 mm). In still other embodiments, the thickness ranges from about 0.07 inches to about 0.15 inches (about 2 mm to about 4 mm)

The thin-layer composites of this disclosure comprise cellulosic fibers as well as noncellulosic fibers. For example, in an embodiment, the composite comprises a mixture of: (i) no more than about 95% by weight of a cellulosic fiber, wherein the fiber has a moisture content of between about 7% to about 20% by weight; (ii) at least about 1% by weight of an organic isocyanate resin; (iii) at least about 1% or about 2% by weight noncellulosic fibers; and (iv) optionally, at least about 0.2% internal release agent by weight and/or at least about 0.1 gram release agent per square foot (about 1 gram per square meter) on the surface of the final composite product.

The present disclosure also encompasses methods of making wood products comprising wood composites. For example, in one embodiment, a wood composite comprises a mixture of: (a) no more than about 95% by weight of a wood fiber; (b) at least about 1% by weight of an organic isocyanate resin; (c) at least about 1% by weight of noncellulosic fibers; (d) optionally, at least about 0.5% by weight of an internal release agent; (e) optionally, at least about 0.1% by weight wax; (f) optionally, at least about 0.5% catalyst, (g) optionally, at least about 1% filler and (h) optionally, at least about 0.2 gram release agent per square foot (about 2 gram per square meter) as applied to the surface of the final composite product.

In certain embodiments, the present disclosure provides methods of making building structures (e.g., headers, jambs, sashes, and stiles) that are not thin-layered structures. For example, to make door jambs and window sills that may have their entire structure, or a substantial portion thereof, comprising the fiber-reinforced polymer disclosed herein, components used to make the polymer (e.g., an isocyanate and an isocyanate-reactive compound) may be mixed, and the mixture poured into a mold having an internal volume that comprises the door core or frame part of interest. The mold may be designed to manufacture plant-on structures for doors, or, the mold may be designed to manufacture window parts or window frame parts. Molds designed to manufacture siding, shutters, and/or shingles may be used. Generally, the disclosed methods may be used with standard molds that are used to manufacture the building part of interest. In one embodiment, the mold comprises fluting or other decorative shaping. Where such additional shaping is included, the polymer layer at the surface may include the additional shaping.

Accordingly, the disclosed methods may form composites that have increased resistance to moisture-induced shrinking and/or swelling as compared to composites with similar concentrations of non-isocyanate resins. The disclosed methods also may be used to form composites having comparable resistance to moisture-induced shrinking and/or swelling as composites having greater concentrations of isocyanate resins. Methods and products demonstrating reduced emissions of Hazardous Air Pollutants (HAP) are also disclosed, while maintaining and improving the physical characteristics of the composites using concentrations previously understood to be unworkable. The Hazardous Air Pollutant reduction is significant and may allow a composite plant to comply with current EPA Maximum Achievable Control Technology (MACT) regulations without installing engineering controls.

The present methods may also result in reduced energy costs, high-throughput production, and reduced over-all costs while maintaining the necessary moisture resistance of the final composite products.

### EXAMPLES

The following examples are intended to further illustrate exemplary embodiments and are not intended to limit the scope of the disclosure.

### Example 1

Door skins were prepared following the processes described herein, with wood chips used as the source of cellulosic material. The wood chips were refined to form cellulosic fibers, and were combined with a release agent, catalyst and a wax then the cellulosic fiber was dried to between 8-15% moisture content. Fiberglass roving was chopped and separated with air and attrition mill blending to produce individualized fiberglass filaments which were added to the cellulosic wood fiber, and the material was combined with an organic isocyanate resin to form a composite mixture. The composite mixture was formed into a loose mat, the mat was pre-compressed, trimmed, and compressed between two dies at an elevated temperature of between 280-330° F. until the desired thickness was reached. Compression at 500 psi for 20 seconds was maintained to cure the resin. The composite product was released from the dies, cut to the desired length and width, and an acrylic primer was sprayed onto the outer surface of the door skin, to provide the finished molded door skin product. If necessary, the door skin is humidified to increase the moisture content of the door skin. The percentages provided in Table 1, below, represent the percentage by dry weight of the finished molded door skin product, which weighed 10.65 lbs for a typical 3-foot by 6-foot 8-inch door skin at 0.120″ thick and 53 pcf density.

TABLE 1
Molded Door Skin Product Specifications (oven dry basis)

| Component | Percent of Finished Product |
|---|---|
| Wood Fiber | 84.8 to 87.4 |
| pMDI Resin | 5.0 to 6.0 |
| Polyol catalyst | 0.8 to 1.0 |
| Wax | 0.7 to 0.9 |
| Internal Release Agent | 0.3 to 0.4 |
| Fiberglass Filaments | 5.5 to 6.5 |
| Acrylic Primer | 0.3 to 0.4 |
| Total | 100.0 |

### Example 2

Two door skins (door skins A and B) were prepared following the processes described herein, with wood chips used as the source of cellulosic material and fiberglass used as the source of noncellulosic material, as described in Example 1.

Door skin A contained no non-cellulosic fibers. It was prepared with refined yellow poplar wood chips to form cellulosic fibers, which were combined with 0.35% of an internal release agent (Aquacer 549 from Byk), 0.9% of a catalyst (WPA 25010 from Huntsman Chemical), and 0.8% of a wax (40SPM from Hexion). The material was combined with an organic isocyanate resin (diphenylmethane-4-4′-diisocyanate from Huntsman Chemical) to form a composite mixture. The composite mixture was formed into a loose mat, the mat was pre-compressed, trimmed, and compressed between two dies at an elevated temperature of about 320° F., such that a thickness of approximately 0.119 inches was obtained. Compression was maintained for 30 seconds to cure the resin. The final composite product was released from the dies and cut to the desired length and width.

Door skin B was prepared following the procedure for door skin A, except that 6% of individualized fiberglass non-cellulosic fibers, with an average length of about 0.5 inches (about 13 mm) were included prior to the resin addition, and that a release agent spray (PB28 from SeaCole) was used on the surface of the pre-compressed mat at an amount of 1.2 gram per square foot. Also, the composite mixture was compressed between two dies at an elevated temperature of about 320° F., such that a thickness of approximately 0.117 inches was obtained. Compression was maintained for 30 seconds to cure the resin.

The data obtained on these two door skins illustrate the advantages of using noncellulosic material as compared to door skins without noncellulosic material. For example, the linear expansion (LE %) of door skin B was at least about 20% less than the LE % of door skin A, when immersed in water for about 24 hours at about 70° F. (about 21.1° C.), following a standard test used in the industry (ASTM D-1037). Also, the door skin strength is higher for door skin B compared to door skin A, as door skin B had a modulus of elasticity (MOE) that was over about 25% more than the MOE of door skin A, also measured using the standard test ASTM D-1037.

### Example 3

With reference to FIG. 5, an individualized noncellulosic fiber of fiberglass is visible in an SEM micrograph (at 800 power) of door skin B, described above, surrounded by cellulosic fibers. The micrograph shows that the glass fiber is not crushed as compared to the cellulosic fibers, and that it is embedded and adheres to the cellulosic fibers. Because of the adhesion and the retained physical integrity of the glass fiber, the strength of the door skin is improved as compared to a door skin without glass fiber, as reflected in its modulus of elasticity. Thus, the glass is able to retain its strength when incorporated into the door skin. Similarly, the micrograph shows that the glass fiber takes up more volume in the door skin than the cellulosic fibers. Because of this volumetric displacement, as compared to door skins made without noncellulosic fibers, there is less cellulosic fiber available to absorb or attract water. This contributes to its increased resistance to moisture-induced shrinking and/or swelling as compared to door skins made without noncellulosic fibers.

It will be understood that each of the elements described above, or two or more together, may also find utility in applications differing from the types described. While the present disclosure illustrates and describes a method for high-throughput preparation of thin-layer composite products, such as door skins, it is not necessarily limited to the details shown, since various modifications and substitutions can be made without departing from the spirit and scope of the present invention.

As such, further modifications and equivalents of the embodiments herein disclosed may occur to persons skilled in the art using no more than routine experimentation and without departing from the underlying principles of the invention. All such modifications and equivalents are believed to be within the spirit and scope of the invention as described herein, and determined only by the following claims.

1. A thin layer composite, comprising:
cellulosic fibers, comprising no more than 95% by weight of the composite;
isocyanate resin, comprising at least 1% by weight of the composite; and
individualized noncellulosic fibers, comprising at least 1% by weight of the composite.

2. The composite of claim 1, wherein the individualized noncellulosic fibers are selected from one or more of glass, polyester, polyamide, and carbon fibers.

3. The composite of claim 1, wherein the individualized noncellulosic fibers are present in the composite in a weight percentage between about 1% and about 40%.

4. The composite of claim 3, wherein the individualized noncellulosic fibers are present in the composite in a weight percentage between about 3% and about 20%.

5. The composite of claim 4, wherein the individualized noncellulosic fibers are present in the composite in a weight percentage between about 5% and about 15%.

6. The composite of claim 1, wherein the individualized noncellulosic fibers are present in the composite in an amount less than about 10% by weight.

7. The composite of claim 1, wherein the individualized noncellulosic fibers are present in the composite in an amount less than about 8% by weight.

8. The composite of claim 1, wherein greater than 65% of the noncellulosic fibers are individualized fibers.

9. The composite of claim 1, wherein greater than 85% of the noncellulosic fibers are individualized fibers.

10. The composite of claim 1, wherein at least 90% by weight of the individualized noncellulosic fibers have a length less than about 1.5 inches.

11. The composite of claim 1, wherein at least 99% by weight of the individualized noncellulosic fibers have a length less than about 1.5 inches.

12. The composite of claim 1, wherein greater than 80% of the individualized noncellulosic fibers are touching each other less than 10% of their lengths, the individualized noncellulosic fibers having a length between about 0.12 inches and about 4 inches.

13. The composite of claim 1, wherein there are three or fewer noncellulosic fiber bundles of more than 10 fibers visible on a door skin formed from the composite.

14. The composite of claim 1, wherein the isocyanate resin comprises diphenylmethane-4-4′-diisocyanate (4,4′-MDI) or toluene diisocyanate (TDI).

15. The composite of claim 1, wherein the composite comprises about 60% to about 95% by weight of cellulosic fiber.

16. The composite of claim 1, wherein the composite comprises about 80% to about 90% by weight of cellulosic fiber.

17. The composite of claim 1, wherein the cellulosic fibers have a moisture content of between about 7% and about 16% by weight before being pressed into the thin layer composite product.

18. The composite of claim 1, wherein the thin layer composite exhibits a percentage of linear expansion of less than about 20% after being immersed for about 24 hours in water at about 70° F. (about 21° C.).

19. The composite of claim 1, wherein the thickness of the composite ranges from about 0.03 inches (about 1 mm) to about 0.19 inches (about 5 mm).

20. The composite of claim 1, wherein the thin layer composite has a density of less than about 60 pounds per cubic foot (about 962 kg/m³).

21. The composite of claim 1, wherein less than 50 ends of noncellulosic fibers protrude per square inch of the exterior surface of the composite by more than ten times the diameter of the noncellulosic fiber.

22. The composite of claim 1, wherein less than 500 ends of noncellulosic fibers protrude per square inch of the exterior surface of the composite by more than 0.005 inches.

23. The composite of claim 1, wherein at least 50% of the cellulosic fibers at or contacting the surface of the composite have ends protruding from the exterior surface at an angle less than 30 degrees with respect to the plane of the surface of the composite.

24. The composite of claim 1, wherein the isocyanate resin comprises a resin with thermoset properties.

25. A method for making a thin layer composite, the method comprising:
individualizing noncellulosic fibers, the noncellulosic fibers selected from one or more of fiberglass, polyester, polyamide, and carbon fibers;
forming a composite mixture including:
the individualized noncellulosic fibers, comprising between about 1% and about 40% by weight of the composite,
cellulosic fibers having a moisture content of between about 7% and about 20% by weight of the cellulosic fibers, the cellulosic fibers comprising no more than about 95% by weight of the composite,
an isocyanate resin, comprising at least 1% by weight of the composite;
pre-compressing the mixture into a loose mat; and
pressing the loose mat between two dies at an elevated temperature and pressure and for a sufficient time to further reduce the thickness of the mat to form a thin layer composite having a thickness of between about 1 mm and about 16 mm.

26. The method of claim 25, wherein the individualized noncellulosic fibers are fiberglass.

27. The method of claim 25, wherein the resin is distributed on the cellulosic and noncellulosic fibers in a mist.

28. The method of claim 25, further comprising cutting from an elongated bundle of noncellulosic fibers a group of noncellulosic fibers prior to individualizing the noncellulosic fibers, the cutting having a length of shorter than about 102 mm.

29. The method of claim 25, wherein the composite mixture comprises about 60% to about 95% by weight of cellulosic fiber.

30. The method of claim 25, wherein the cellulosic fibers have a moisture content of between about 7% and about 16% by weight before pressing the loose mat between the dies.

31. The method of claim 25, wherein the temperature used to press the mat ranges from about 250° F. (about 121° C.) to about 400° F. (about 204° C.).

32. The method of claim 25, wherein the ram pressure of the dies used to press the mat ranges from about 100 psi (about 7 kg/cm²) to about 2500 psi (about 176 kg/cm²).

33. The method of claim 25, wherein the isocyanate resin comprises a resin with thermoset properties.

34. A door, comprising
a door core; and
two door skins surrounding and adhered to the door core, the door skins comprising a composite, the composite comprising:
individualized noncellulosic fiberglass fibers comprising between about 1% and about 40% by weight of the composite,
cellulosic fibers comprising between about 60% to about 95% by weight of the composite, and
an isocyanate resin comprising at least 1% by weight of the composite.

35. A door skin comprising a composite, the composite comprising:
cellulosic fibers, comprising no more than 95% by weight of the composite;
isocyanate resin, comprising at least 1% by weight of the composite; and
individualized noncellulosic fibers, comprising at least 1% by weight of the composite.
